(19) United States
(12) Patent Application Publication
(10) Pub. No.: US 2014/0272302 A1
(43) Pub. Date: Sep. 18, 2014

(54) ARCHITECTURAL FINISH, RECYCLED AGGREGATE COATING AND EXTERIOR INSULATED ARCHITECTURAL FINISH SYSTEM

(71) Applicant: Romeo Ilarian Ciuperca, Norcross, GA (US)

(72) Inventor: Romeo Ilarian Ciuperca, Norcross, GA (US)

(21) Appl. No.: 14/214,815

(22) Filed: Mar. 15, 2014

Related U.S. Application Data
(60) Provisional application No. 61/789,093, filed on Mar. 15, 2013.

(51) Int. Cl. E04C 2/04; E04B 1/76; C04B 20/00

(52) U.S. Cl. CPC E04C 2/049; C04B 20/00; E04B 1/762
USPC 428/150; 427/201; 428/143; 428/149

(57) ABSTRACT

The invention comprises a product. The product comprises a substrate having a first primary surface and an opposite second primary surface and a layer of cementitious material on the first primary surface. The product further comprises decorative aggregate particles partially embedded in the layer of cementitious material. A method of making the product is also disclosed.

### CROSS-REFERENCE TO RELATED APPLICATIONS

The present application claims the benefit of the filing date of U.S. provisional patent application Ser. No. 61/789,093 filed Mar. 15, 2013.

### FIELD OF THE INVENTION

The present invention generally relates to architectural decorative surface finishes. More specifically, the present invention relates to an architectural decorative surface finish on a substrate, especially an insulating foam panel. The present invention also relates to a method of forming an architectural decorative surface finish on a substrate, especially an insulating foam panel. More specifically the present invention relates to an exterior insulated architectural finish system.

### BACKGROUND OF THE INVENTION

Decorative surface finishes for various substrates are desired for many structures. A frequently used system is EIFS (“Exterior Insulation Finish System”) (sometimes referred to as synthetic stucco), which is a type of building exterior wall cladding system that provides exterior walls with an insulated finished surface and waterproofing in an integrated composite material system. EIFS consists of three layers. The first layer is a layer of plastic foam, usually expanded polystyrene, typically adhesively applied with a cementitious acrylic base coat using a notched trowel to a substrate such as concrete, gypsum board or plywood. The adhesive base coat is then allowed to cure for approximately 24 to 48 hours. The foam is sanded or rasped using heavy grade sand paper. Once the exterior face of the foam is smooth and plane, the exterior of the foam is coated with a cementitious base coat and reinforcing material. Applied to the exterior face of the foam is a layer of fiberglass mesh embedded in an acrylic cementitious base coat. The first base coat layer is usually applied with a steel trowel. The fiberglass mesh is then applied to the uncured base coat and a second layer of base coat is applied to fully embed the fiberglass mesh. The base coat is then allowed to cure, typically for 24 to 48 hours depending on the ambient temperature and humidity. The final layer is a textured finish coat. The textured finish coat is made of various sizes of aggregate suspended in an acrylic or elastomeric binder material. The finish coat can be tinted to a desired color using synthetic pigments. Thus, the textured finish coat is a color integrated acrylic or elastomeric material. The finish coat color is provided by the synthetic pigment that tints the acrylic binder, hence the name “synthetic stucco”. The finish coat is applied to the cured base coat layer in two steps. First, the finish coat is spread using a steel trowel to the thickness of the aggregate so as not to run or sag on the wall. Second, after the finish coat starts to set, the textured finish coat is floated usually using a plastic or wooden floating trowel. All of these steps are performed at a worksite. Thus, the EFIS system is a multi-step, time consuming, labor-intensive process that take anywhere from 3-5 days to complete. EIFS systems are by nature a synthetic product using synthetic color pigments that limit the architectural finishes to synthetic finishes.

It would be desirable to provide an insulated exterior finish system that is easier and simpler to install. It would also be desirable to provide finish systems that can be installed in a shorter amount of time and with less labor. It would be desirable to provide finish systems that can use exposed natural stone aggregate and mineral elements to create a natural architectural finish look. It would also be desirable for such a system to provide for a wide variety of decorative or architectural finishes. It would further be desirable to provide such a system that incorporates recycled or repurposed materials. Most importantly, it would be desirable to provide an insulated exterior finish system that provides a waterproof barrier but at the same time allows for moisture permeability equal to, or exceeding, existing building codes.

### SUMMARY OF THE INVENTION

The present invention satisfies the foregoing needs by providing a cementitious coating in which architectural decorative aggregate, preferably recycled architectural decorative aggregate, is partially embedded.

In one disclosed embodiment, the present invention comprises a product. The product comprises a substrate having a first primary surface and an opposite second primary surface and a layer of cementitious material on the first primary surface. The product also comprises decorative aggregate particles partially embedded in the layer of cementitious material.

In another disclosed embodiment, the present invention comprises a method. The method comprises applying a layer of cementitious material to a first primary surface of a substrate and partially embedding decorative aggregate particles in the layer of cementitious material before the layer of cementitious material has reached final set or cure.

Accordingly, it is an object of the present invention to provide an improved architectural decorative surface finish.

Another object of the present invention is to provide an improved method of making an architectural decorative surface finish.

A further object of the present invention is to provide an improved exterior insulated architectural finish system.

Another object of the present invention is to provide an exterior insulated architectural finish system that meet or exceed existing building codes requirements for moisture permeability.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a partial perspective view of a disclosed embodiment of the aggregate coating of the present invention.

FIG. 2 is a cross-sectional view taken along the line 2-2 of the aggregate coating shown in FIG. 1.

### DETAILED DESCRIPTION OF THE DISCLOSED EMBODIMENTS

Referring now to the drawing in which like numbers indicate like elements throughout the several views, there is shown in FIG. 1 a substrate 10. The substrate 10 can be any desired size, shape or thickness, but preferably is in the shape of a rectangular panel. The substrate 10 can be concrete, gypsum board, cement board, concrete block, wood, plywood or any other suitably rigid, construction material used to build walls and ceilings. However for this disclosed embodiment of the present invention, the substrate 10 is preferably made from closed cell polymeric foam, such as molded expanded polystyrene or extruded expanded polystyrene. Other polymeric foams can also be used including, but nor limited to, polyisocyanurate and polyurethane. If the foam substrate 10 is made from a material other than polystyrene, the foam insulating panels should each have insulating properties equivalent to approximately 0.5 to approximately 8 inches of expanded polystyrene foam; preferably at least 0.5 inches of expanded polystyrene foam; more preferably at least 1 inch of expanded polystyrene foam; most preferably at least 2 inches of expanded polystyrene foam; especially at least 3 inches of expanded polystyrene foam; more especially at least 4 inches of expanded polystyrene foam and most especially at least 6 inches of expanded polystyrene foam. Preferably, the foam substrate 10 has insulating properties equivalent about 0.5 inches of expanded polystyrene foam; about 1 inch of expanded polystyrene foam; about 2 inches of expanded polystyrene foam; about 3 inches of expanded polystyrene foam; about 4 inches of expanded polystyrene foam; about 6 inches of expanded polystyrene foam or about 8 inches of expanded polystyrene foam. Expanded polystyrene foam has an R-value of approximately 4 to 5 per inch thickness. Therefore, the foam substrate 10 should have an R-value of greater than 2, preferably greater than 4, more preferably greater than 8, most preferably greater than 12, especially preferably greater than 16, more especially greater than 20. The foam substrate 10 preferably has an R-value of approximately 4 to approximately 40; more preferably between approximately 10 to approximately 40; especially approximately 12 to approximately 40; more especially approximately 20 to approximately 40. The foam substrate 10 preferably has an R-value of approximately 4, more preferably approximately 8, especially approximately 12, most preferably approximately 16, especially approximately 20 or more especially approximately 40.

The foam substrate 10 should also have a density sufficient to make it substantially rigid, such as approximately 1 to approximately 3 pounds per cubic foot, preferably approximately 1.5 pounds per cubic foot. Expanded closed cell polystyrene foam is available under the trademark Neopor® and is available from Georgia Foam, Gainesville, Ga., USA. Extruded polystyrene is available from Dow Chemicals, Midland, Mich., USA. The foam substrate 10 can be made by molding to the desired size and shape, by cutting blocks or sheets of pre-formed expanded polystyrene foam into a desired size and shape or by extruding the desired shape and then cutting to the desired length.

The foam substrate 10 optionally has a layer of reinforcing material 12 on one primary surface 14 thereof. Optionally, the other primary surface 16 of the foam substrate 10 is preferably attached to a secondary substrate 18 such as any sheathing material including but not limited to, plywood, dens glass, gypsum board, cement board and the like that are part of any framing wall system. In a preferred disclosed embodiment of the present invention, the secondary substrate is a layer of concrete 18, such as a precast concrete panel, a cast in place concrete wall, a masonry wall or the like. The foam substrate 10 can be attached to the primary substrate 14 by any means know in the art such as mechanical fasteners, adhesives or both mechanical and adhesive attachment. The method of attachment of the foam substrate 10 to the primary substrate 14 is not a critical feature of the present invention. When the foam substrate 10 is partially or wholly attached to a concrete substrate, the foam substrate can be attached to the concrete substrate as described in U.S. Pat. Nos. 8,555,583 and 8,555,584; U.S. Publication No. 2013/0074432; and U.S. patent application Ser. No. 13/626,087 filed Sep. 25, 2012; Ser. No. 13/834,574 filed Mar. 15, 2013 and Ser. No. 13/834,697 filed Mar. 15, 2013 (all of which are incorporate herein by reference in their entirety).

The layer of reinforcing material 12 can be made from continuous materials, such as sheets or films, or discontinuous materials, such as fabrics, webs or meshes. The layer of reinforcing material 12 can be made from material such as polymers, for example polyethylene or polypropylene, from fibers, such as fiberglass, basalt fibers, aramid fibers or from composite materials, such as carbon fibers in polymeric materials, or from metal, such as steel or aluminum wires, expanded metal lath, sheets or corrugated sheets, and foils, such as metal foils, especially aluminum foil. The layer of reinforcing material 12 can be made from metal, but preferably is made from synthetic plastic materials that form the warp and weft strands of a fabric, web or mesh. A preferred material for the layer of reinforcing material 12 is disclosed in U.S. Pat. No. 7,625,827 (the disclosure of which is incorporated herein by reference in its entirety). Also, the layer of reinforcing material 12 can be made from carbon fiber, alkaline resistant fiberglass, basalt fiber, aramid fibers, polypropylene, polystyrene, vinyl, polyvinyl chloride (PVC), or nylon, or from composite materials, such as carbon fibers in polymeric materials, or the like. For example, the layer of reinforcing material 12 can be made from the mesh or lath disclosed in any of U.S. Pat. Nos. 5,836,715; 6,123,879; 6,263,629; 6,454,889; 6,632,309; 6,898,908 or 7,100,336 (the disclosures of which are all incorporated herein by reference in their entirety).

The layer of reinforcing material 12 can be adhered to the first primary surface 14 of the foam substrate 10 by a conventional adhesive that is compatible with the material from which the foam substrate is made. However, it is preferred that the layer of reinforcing material 10 be laminated or embedded onto the first primary surface 14 of the foam substrate 10 using a polymeric material that also forms a weather or moisture barrier (elastomeric weather membrane) on the exterior surface of the foam substrate. The elastomeric weather membrane can be applied to the layer of reinforcing material 12 on the first primary surface 14 of the foam substrate 10 by any suitable method, such as by spraying, brushing or rolling. The elastomeric weather membrane can be applied as the laminating agent for the layer of reinforcing material 12 or it can be applied in addition to an adhesive used to adhere the layer of reinforcing material to the first primary surface 14 of the foam substrate 10. The elastomeric weather membrane does not include portland cement. Suitable polymeric materials for use as the elastomeric weather membrane are any water resistant elastomeric polymeric material that is compatible with both the material from which the layer of reinforcing material 12 and the foam substrate 10 are made; especially, liquid applied weather membrane materials. Useful liquid applied weather membrane materials include, but are not limited to, WeatherSeal® by Parex of Anaheim, Calif. (a 100% acrylic elastomeric waterproof membrane and air barrier which can be applied by rolling, brushing, or spraying) or Senershield® by BASF (a one-component fluid-applied air/water-resistive barrier that is both waterproof and resilient) available at most building supply stores. The elastomeric membrane has to meet the building codes requirement for air permeance, vapor permeance and elongation factors. For relatively simple applications, where cost is an issue or where simple exterior finish systems are desired, or for interior applications, or in cases where the insulating foam substrate is omitted, the layer of reinforcing material 12 can be omitted.

A preferred elastomeric weather membrane is a combination of an elastomeric polymer, such as WeatherSeal®, and 0.1% to approximately 50% by weight ceramic fibers, preferably 0.1% to 40% by weight, more preferably 0.1% to 30% by weight, most preferably 0.1% to 20% by weight, especially 0.1% to 15% by weight, more especially 0.1% to 10% by weight, most especially 0.1% to 5% by weight. Ceramic fibers are fibers made from materials including, but not limited to, silica, silicon carbide, alumina, aluminum silicate, aluminum oxide, magnesium oxide, zirconia, and calcium silicate. Wollastonite is an example of a ceramic fiber. Wollastonite is a calcium inosilicate mineral (CaSiO₃) that may contain small amounts of iron, magnesium, and manganese substituted for calcium. Wollastonite is available from NYCO Minerals of NY, USA. Bulk ceramic fibers are available from Unifrax I LLC, Niagara Falls, N.Y., USA. Ceramic fibers are known to block heat transmission and especially radiant heat. When placed on the exterior surface of a building wall, ceramic fibers improve the energy efficiency of the building envelope. Additionally, any other type of mineral with thermal insulating properties, such as magnesium oxide or other types of oxides, can be used as additives to the cementitious material.

Optionally, Wollastonite can be used in the elastomeric weather membrane to both increase resistance to heat transmission and act as a fire retardant. Therefore, the elastomeric weather membrane can obtain fire resistance properties or reduced flame spread properties. A fire resistant membrane over the exterior face of the foam substrate 10 can increase the fire rating of the wall assembly by delaying the melting of the foam substrate and/or reducing the flame spread properties.

On the layer of reinforcing material 12 (or on the first primary surface 14 of the foam substrate 10, if the layer of reinforcing material is not present) is a layer of cementitious material 20. The layer of cementitious material 20 is preferably a polymer modified concrete, polymer modified mortar or polymer modified plaster.

Polymer modified concrete, polymer modified plaster, and polymer modified mortar are known in the art and comprises a conventional concrete, plaster or mortar mix to which a polymer is added in an amount 0.1% to 50% by weight polymer, preferably 0.1% to 35% by weight polymer, more preferably approximately 1% to approximately 25% by weight, most preferably approximately 5% to approximately 20% by weight. Polymer modified concrete can be made using the polymer amounts shown above in any of the concrete formulations shown below. Polymers suitable for addition to concrete, plaster or mortar mixes come in many different types: thermoplastic polymers, thermosetting polymers, elastomeric polymers, latex polymers and redispersible polymer powders. A preferred thermoplastic polymer is an acrylic polymer. Latex polymers can be classified as thermoplastic polymers or elastomeric polymers. Latex thermoplastic polymers include, but are not limited to, poly(styrene-butyl acrylate); vinyl acetate-type copolymers; e.g., poly(ethyl-vinyl acetate) (EVA); polyacrylic ester (PAE); polyvinyl acetate (PVAC); and polyvinylidene chloride (PVDC). Latex elastomeric polymers include, but are not limited to, styrene-butadiene rubber (SBR); nitrile butadiene rubber (NBR); natural rubber (NR); polychloroprene rubber (CR) or Neoprene; polyvinyl alcohol; and methylcellulose. Redispersible polymer powders can also be classified as thermoplastic polymers or elastomeric polymers. Redispersible thermoplastic polymer powders include, but are not limited to, polyacrylic ester (PAE); e.g., poly(methyl methacrylate-butyl acrylate); poly(styrene-acrylic ester) (SAE); poly(vinyl acetate-vinyl versatate) (VA/VeoVa); and poly(ethylene-vinyl acetate) (EVA). Redispersible elastomeric polymer powders include, but are not limited to, styrene-butadiene rubber (SBR).

It is specifically contemplated that the cementitious-based material from which the layer of cementitious material 20 is made can include reinforcing fibers made from material including, but not limited to, steel, plastic polymers, glass, basalt, Wollastonite, carbon, cellulose and the like. The use of reinforcing fiber in the layer of cementitious material 20 made from polymer modified concrete, polymer modified mortar or polymer modified plaster provide the layer of cementitous material with improved flexural strength, as well as improved impact resistance and blast resistance. When the polymer modified cementitious material is used over the elastomeric weather membrane, the bond of the polymer modified cementious material to the substrate is greatly improved.

Wollastonite can be used in the layer of cementitious material 20 to increase compressive and flexural strength as well as impact resistance. Also, Wollastonite can improve resistance to heat transmission and add fire resistance to the exterior plaster. Therefore the coating can obtain fire resistance properties as well as improved energy efficiency properties. A fire resistant material over the exterior face of the foam can increase the fire rating of the wall assembly by delaying the melting of the foam. Increased resistance to heat transmission will also increase the building energy efficiency and therefore lower energy cost, such as heating and cooling expenses.

The layer of cementitious material 20 can be applied to the first primary surface 14 of the foam substrate 10 or the layer of reinforcing material 12, if present, by any suitable method, such as by spraying, by pouring, by hand troweling, by casting or by extrusion. For example, a polymer modified concrete, plaster or mortar is applied to the first primary surface 14 of the foam substrate 10 and the layer of reinforcing material 12, if present, by spraying to a desired thickness, such as approximately ⅛ inch to approximately 1 inch; preferably approximately ⅛ inch, preferably approximately ¼ inch, preferably approximately 0.5 inches, preferably approximately 0.75 inches, and preferably approximately 1 inch. The polymer modified concrete, plaster, or mortar is preferably applied to the first primary surface 14 of the foam substrate 10 and the layer of reinforcing material 12 by extrusion to a desired thickness, preferably approximately ⅛ inch to approximately 1 inch. The sprayed, poured, cast or extruded polymer modified concrete, polymer modified plaster or polymer modified mortar on the foam substrate 10 and the layer of reinforcing material 12, if present, can be optionally smoothed with a hand trowel to form an even, smooth surface or left in its natural state.

While the layer of cementitious plaster material 20 is in the intermediate state between the initial set and before the final set and before the layer of cementitious material 20 cures, a layer of decorative aggregate 22 is formed in the still soft layer of cementitious material such that the decorative aggregate is only partially embedded in the layer of cementitious material; i.e., a portion of each decorative aggregate particle is on or below the surface 24 of the layer of cementitious material and a portion of each decorative aggregate particle is above the surface of the layer of cementitious material, as shown in FIG. 2. The decorative aggregate particles are preferably 10% embeded in the layer of cementitious material 20 (i.e., 10% of the surface area of an aggregate particle), more preferably 25% embeded in the layer of cementitious material, most prefereably 30% embeded in the layer of cementitious material, especially 40% embeded in the layer of cementitious material and more especially 50% embeded in the layer of cementitious material, most especially 75% embedded in the layer of cementitious material, even more especially 90% embedded in the layer of cementitious material.

The layer of decorative aggregate 22 can be partially embeded in the layer of cementitious material 20 by any suitable method, such as by broadcasting into the layer of cementitious material followed by pushing the decorative aggregate particles partially into the layer of cementitious material by using a roller. However, the layer of decorative aggregate 22 is preferably formed in the layer of cementitious material 20 by blowing decorative aggregate particles into the layer of cementitious material using compressed air. After blowing the decorative aggregate particles into the layer of cementitious material 20 if additional embedment of the decorative aggregate particles in the layer of cementitious material is necessary, the decorative aggregate particles can be pushed partially into the layer of cementitious material by using a roller.

The layer of decorative aggregate 22 can be made from virgin material, but is preferably made from recycled materials; i.e., post-consumer or post-industrial materials. The decorative aggregate particles can be any decorative and/or colorful stone, semi-precious stone, quartz, granite, basalt, marble, stone pebbles, glass or shells. The decorative aggregate particles can be made from stone including, but not limited to, amethyst, azul bahia, azul macaubas, foxite, glimmer, honey onyx, green onyx, sodalite, green jade, pink quartz, white quartz, and orange calcite. The decorative aggregate particles can be made from crushed glass including, but not limited to, recycled clear glass, recycled mirror glass, recycled clear plate glass, recycled cobalt blue glass, recycled mixed plate glass, and recycled black glass. The decorative aggregate particles can be made from recycled aggregate including, but not limited to, recycled amber, recycled concrete and recycled porcelain. The decorative aggregate particles can be made from non-recycled glass including, but not limited to, artificially colored glass, reflective glass, transparent glass, opaque glass, frosted glass and coated glass. The decorative aggregate particles can be made from tumbled glass including, but not limited to, jelly bean and glass beads. Decorative aggregate can be obtained from Arim Inc., Teaneck, N.J., USA.

The decorative aggregate particles can be any suitable size, but preferably are size #000 (passes mesh 16, retained on mesh 25) to size #3 (½ inch to ⅜ inch), more preferably size #00 (passes mesh 10, retained mesh 16) to size #2 (⅜ inch to ¼ inch) and most preferably size #00 (passes mesh 10, retained mesh 16) to size #1 (¼ inch to ⅛ inch). The decorative aggregate particles preferably have irregular, random shapes. However, for certain applications it may be desirable for the aggregate particles to have uniform shapes, such as are obtained by tumbling the aggregate, for example jelly bean shaped or bead shaped.

Use of the present invention will now be considered. The layer of cementitious material 20 is formed on the substrate 10 as described above. It is a critical aspect of the present invention that the layer of aggregate 22 be broadcast or formed on the layer of cementitious material 20 before the cementitious material has reached final set or cured; i.e., the cementitious material is in the intermediate state between initial and final set, such that it is still soft so that aggregate broadcast into the layer of cementitious material will only partially penetrate the surface of the layer of cementitious material. The partially set layer of cementitious material 20 is sufficiently sticky such that when the aggregate particles impact the layer of cementitious material and are partially embedded therein, the aggregate particles will stick to the layer of cementitious material and remain embedded therein until the layer of cementitious material is finally set and cured thereby securely attaching the aggregate particles thereto. Therefore, the layer of aggregate 22 must be formed in the layer of cementitious material 20 relatively quickly after the layer of cementitious material is applied to the foam substrate 10. Depending on the formulation of the layer of cementitious material, ambient temperature conditions and work schedules, it may be desirable to add either curing accelerators or retarders to the cementitious material.

The layer of aggregate 22 can be formed in the layer of cementitious material 20 in a number of ways. The layer of aggregate 22 can be formed in the layer of cementitious material 20 with the substrate 10 in either a horizontal or a vertical orientation. The aggregate particles can be broadcast into the layer of cementitious material 20 manually or by machine. It is preferred in practicing the present invention that the aggregate particles that form the layer of aggregate 22 be blown into the layer of cementitious material 20 using compressed air. There are numerous machines that are suitable for blowing aggregate particles. Such machines typically use a hopper for holding a supply of the aggregate particles and a feeder system for feeding the aggregate into a stream of compressed air. The compressed air, including the entrained aggregate particles, is then directed through a hose and ejected out of a nozzle of an appropriate design and size for spraying aggregate of the desired size. Hoper guns are commonly used to spray drywall textures on walls and are sold at any home improvement store, such as Home Depot. Another such hopper gun system useful in the present invention is the Cyclone gunite machine or the HGA-530 grout mixer/pump both of which are available from Airplaco Equipment Company, Cincinnati, Ohio, USA. Alternately, the aggregate particles can be loaded into a pressurized air tank and then fed to a spray hose and nozzle. One such pressurized tank system useful in the present invention is the Powder Monkey ANFO loader available from Airplaco Equipment Company, Cincinnati, Ohio, USA.

The aggregate particles that form the layer of aggregate 22 can be broadcast or blown into the partially set layer of cementitious material 20 in a dry state. However, it is preferred that the aggregate particles be mixed with a concrete densifier or clear acryclic polymer prior to broadcast or blowing into the layer of cementitious material 20. Concrete densifiers are a chemical that reacts chemically with alkaline materials in concrete, or any other type of cementitious material, to produce a more dense, durable and chemically resistant product. Concrete densifiers are silica-based compounds that react with lime (calcium hydroxide) in concrete or cement based compositions. Concrete densifiers, also referred to as concrete hardeners, are typically classified as magnesium fluorosilicates (MgSiF₆.6H₂O), lithium silicates (SiO₂/Li₂O), potassium silicates (SiO₂/K₂O), and sodium silicate (SiO₂/Na₂O) and amorphous silica (colloidal silica). Sodium, potassium, magnesium and lithium silicates all react with calcium hydroxide, a byproduct of cement hydration, to produce calcium silicate hydrate (C-S-H), which is the same binder that results from assing water to cement. Magnesium fluourosilicate is commercially available as Lapidolith® from BASF Construction Chemicals, LLC, Shakopee, Minn., USA. Potassium silicate is commercially available as Scofield Formula One K from L.M. Scofield Company, Douglasville, Ga., USA. Lithium silicate is commercially available as LiON HARD from L&M Construction Chemicals, Inc., Omaha, Neb., USA. Sodium silicate is commercially available as Scofield Formula One SG from L.M. Scofield Company, Douglasville, Ga., USA. Amorphous silica is commercially available as H&C® Clear Liquid Hardener & Densifier from H&C Decorative Concrete Products, Cleveland, Ohio, USA.

The concrete densifier can be combined with the aggregate particles in the aggregate spraying system. For example, the aggregate particles and concrete densifier can be added to the hopper of a Cyclone gunite machine or the HGA-530 grout mixer/pump. Then, the aggregate particles coated with concrete densifier can be wet sprayed into the partially set layer of cementitious material 20 to form the layer of aggregate 22. Alternatively, the aggregate particles can be broadcast or sprayed in a dry state dry into the layer of cementitious material 20 to form the layer of aggregate 22. Then, the concrete densifier can be sprayed onto the layer of decorative aggregate 12 and layer of cementitious material 20. Application rates for the concrete densifier in the present invention are the same as those for conventional application to concrete. Generally speaking, those application rates are approximately 200 to 500 square feet of concrete per gallon of concrete densifier. However, if the layer of cementitious material 20 is polymer modified concrete, plaster or mortar, the application rate can be reduced. After, the concrete densifier is applied, it is permitted to cure completely.

Alternatively the densifier can be applied to the layer of decorative aggregate 22 after the aggregate is embedded into the polymer modified concrete, polymer modified plaster or polymer modified mortar by any suitable method, such as by spraying.

For some applications, it may be desirable to apply a polymer coating to the layer of decorative aggregate 22 in the layer of cementitious material 20. The aggregate can be mixed with a clear acrylic polymer and then broadcast or blown wet into the partically set layer of cementitious material 20 in the same manner described above.

Alternatively, the polymer can be applied after the aggregate is partially embedded into the layer of cementiotious material 20. Therefore, after the layer of decorative aggregate 22 has been partially embedded in the layer of cementitious material 20, a layer of a polymeric coating can be applied over the layer of decorative aggregate. Suitable polymeric coatings include any materials that are compatible with both the layer of decorative aggregate 22 and the layer of cementitious material 20 and include, but are not limited to, polyurethane, acrylic, epoxy, and the like. Such polymer coatings are preferably clear so as not to alter the color of the decorative aggregate.

For most application, it is desirable to use white portland cement in the layer of cementitious material 20. For other application, it may be desirable to add a colored pigment to the layer of cementitious material 20. Various visual effects can be produced by using a colored pigment in the layer of cementitious material 20. For example, a colored pigment matching the color of the layer of decorative aggregate 22 can be used. Or a lighter color or a contrasting or complimentary color of pigment can be used in the layer of cementitious material 20. Also, blends of different colors of aggregate can be used for the layer of decorative aggregate 22. Furthermore, the layer of decorative aggregate 22 can be selectively applied to the layer of cementitious material 20, such as by masking portions of the layer of cementitious material before the layer of decorative aggregate 22 is applied thereto. Then, the masking can be changed to protect the area to which the layer of decorative aggregate 22 has already been applied and the leaving the other portion mask free or selectively applying the mask to the remaining portion. Then, a different color or texture of decorative aggregate can be applied to the unmasked portion of the layer of cementitious material 20. By selectively applying different colors and/or textures and/or types of aggregate to different portions of the layer of cementitious material 20, different graphic designs or effects can be made on the layer of cementitious material by the layer of decorative aggregate 22. Furthermore, since the layer of decorative aggregate 22 is made from natural materials, its color and texture will not fade or change even under harsh sun and weather conditions.

As stated above, the substrate 10 can be an insulating foam panel, such as polystyrene foam. And, optionally, the substrate 10 can be attached to a concrete substrate 18, such as a concrete panel or a concrete wall. If it is desired to attach the foam substrate 10 to a concrete panel or wall substrate 18, it is preferred that it be attached using the methods and apparatus disclosed in any of U.S. Pat. Nos. 8,555,583 and 8,555,584; U.S. Publication No. 2013/0074432; and U.S. patent application Ser. No. 13/626,087 filed Sep. 25, 2012; Ser. No. 13/834,574 filed Mar. 15, 2013 and Ser. No. 13/834,697 filed Mar. 15, 2013 (all of which are incorporate herein by reference in their entirety). Of course, the foam substrate 10 can also be attached to a concrete substrate 18 by conventional mechanical means, such as by bolts or screws, or by adhesives. It is preferred that the foam substrate 10 and concrete substrate 18 are formed as an elevated wall using the foam substrate as an insulated concrete form. It is especially preferred that the concrete substrate be formed as a precast concrete panel, either with the foam attached as a part of the precast process or attached to the concrete panel after the concrete panel is completed. Applicant's co-pending patent application mentioned above, describe how these different structures can be made.

Alternatively, the foam substrate 10 can be attached by any suitable means, such as by an adhesive or by mechanical fasteners, to any type sheathing, such as plywood, gypsum board, cement board, and the like, that is attached to any framing members in the same manner as the foam board is used in Exterior Insulated Finish Systems (EIFS). EIFS installation comprises attaching a foam board to a substrate, then rasping the foam board flat to eliminate any planar irregularities, followed by the troweling of a layer of base coat. Then, a reinforcing mesh is embedded into the base coat, followed by another layer of base coat to fully embed the mesh into the base coat. After the base coat is fully cured (a process that take 24-48 hrs depending on the ambient temperature and humidity conditions), an acrylic textured finish coat is trowled over the base coat. While acrylic textured finish coat is left to set, the finish coat of acrylic textured finish is floated against the cured base coat to achieve the desired texture pattern. Therefore, the EIFS installation has 6-7 distinct steps over 3-5 days time, as described above, making it a time consuming and rather costly installation. One of the features of the present invention is reducing the amount of labor and reducing the number of steps required to achieve an architectual finish, especially an insulated architectural finish. Since the foam substrate 10 can have a reinforcing mesh laminated to a primary surface thereof with an elastomeric weather membrane at a manufacturing facility (“composite foam panel”), the present invention eliminates the need and step of embedding the mesh at a worksite. Since composite foam panel can be delivered to the jobsite, installation is significantly easier and simpler. The composite foam panel can be mechanically or adhesively attached to any suitable substrate in the same manner as EIFS. The present invention thus eliminate the need for applying the reinforcing mesh and base coat in the field as is customary in the EIFS system. Thus, the present invention saves time and money. Furthermore, since the composite foam panel is already cured at the time of delivery to a jobsite, the polymer modified cementitious plaster or mortar material can be applied immediately once the foam panel is installed, thus eliminating a wait of 24-48 hrs to cure the base coat. Once the composite foam panel is installed, the polymer modified cementitius coating and the aggregate finish can be applied immediately, therefore completing the installation of the insulated architectural finish system in the same day in only two steps. The present invention reduces the installation time of a typical insulated finish system, such as the EIFS system, from 3-5 days to approximately 1-2 days. Furthermore, one of the draw back of the EIFS systems is that only acrylic finishes can be used. Acrylyc finishes exclusively use synthetic pigments and have limited aesthetic and archtiectural appeal. The present invention has unlimited material options to achieve a natural stone and/or mineral finish with a wide variety of color and finish options.

The present invention can also be made in an alternate way. This alternate disclosed embodiment is a one-step process for practicing the present invention in a precast concrete process. First, a relatively thick polymeric foam sheet, such as a 0.25 to 0.5 inch thick sheet of polyethylene foam, is cut to the desired size of the precast concrete panel. The decorative aggregate is then heated to a temperature approximately equal to or below the softening or melting temperature of the polymeric foam. The polymeric form sheet is placed on a horizontal surface, such as the bottom of a precast form or mold. The heated decorative aggregate is then broadcast evenly over the surface of the polymeric foam. The heated decorative aggregate then partially melts the polymeric foam thereby sinking into the thickness of the foam. A thin layer, such as between ¼ inch and 1 inch, of polymer modified concrete, polymer modified plaster or polymer modified mortar is then poured over the polymeric foam sheet and embedded decorative aggregate. Then the composite foam panel disclosed U.S. patent application Ser. No. 13/626,087 filed Sep. 25, 2012 (the disclosure of which is incorporated herein by reference in its entirety) is layed on top of the polymer modified plaster or mortar so that the architectural finish is attached to the foam panel portion of the insulated precast concrete panel described in Ser. No. 13/626,087. Alternatively, instead of the foam panel layed on top of the polymer modified plaster or mortar, an optional layer of concrete of a desired thickness is poured over the thin layer of polymer modified concrete, polymer modified plaster or polymer modified mortar. The entire composite is allowed to cure for a time sufficient to gain sufficient strength to be moved for further curing or erected into a vertical position. The polymeric foam sheet is then stripped from the layer of decorative aggregate. This leaves the layer of decorative aggregate partially embedded in the polymer modified concrete, polymer modified plaster or polymer modified mortar, which is also attached to the thicker concrete panel or any other type of board, such as a cement board, to create a board finish product.

In another alternate disclosed embodiment, the present invention can be made in the same way as described above. However, instead of using a polymeric foam sheet and heated decorative aggregate, this embodiment is practiced using a plastic sheet with a contact adhesive on one side thereof. The plastic sheet is cut to the desired size of the precast concrete panel. The plastic sheet is placed on a horizontal surface, such as the bottom of a precast concrete form or mold, with the adhesive side up. The decorative aggregate is then broadcast evenly over the adhesive surface of the plastic sheet. A thin layer, such as between ¼ inch and 1 inch, of polymer modified concrete, plaster or mortar is then poured over the plastic sheet and adhered decorative aggregate. Then, the composite foam panel disclosed U.S. patent application Ser. No. 13/626,087 filed Sep. 25, 2012 (the disclosure of which is incorporated herein by reference in its entirety) is layed on top of the polymer modified plaster or mortar so that the architectural finish is attached to the foam panel portion of the insulated precast concrete panel described in Ser. No. 13/626,087. Alternatively, instead of the foam panel layed on top of the polymer modified plaster or mortar, an optional layer of concrete of a desired thickness is poured over the thin layer of polymer modified concrete, plaster or mortar. The entire composite is allowed to cure for a time sufficient to gain sufficient strength to be moved for further curing or erected into a vertical position. The plastic sheet is then stripped from the layer of decorative aggregate. This leaves the layer of decorative aggregate partially embedded in the polymer modified concrete, plaster or mortar, which is also attached to the thicker concrete panel or any other type of board, such as a cement board, to create a board finish product.

In an alternate disclosed embodiment, the present invention is made as follows. The foam substrate 10 is applied to a secondary substrate 18, such as plywood, dens glass, gypsum board, cement board and the like. The second primary surface 16 of the foam substrate 10 can be attached to the secondary substrate 18 by any suitable adhesive or mechanical attachment means. Additional pieces of foam substrate (not shown) can be attached to the secondary substrate 18 adjacent the foam substrate 10 to cover a desired area of the secondary substrate. If necessary, the first primary surface 14 of the foam substrate 10 can be planed, rasped or otherwise rendered to a flat smooth surface with the adjoining pieces of foam substrate (not shown), if present. A coating of the elastomeric weather membrane, as disclosed above, is then applied to the first primary surface 14 of the foam substrate. The layer of reinforcing material 12, if present, is then applied to the first primary surface 14 of the foam and a coating of the elastomeric weather membrane is applied to the layer of reinforcing material thereby attaching and encapsulating the layer of reinforcing material in the elastomeric weather membrane. Alternatively, the layer of reinforcing material can be completely omitted or the layer of reinforcing material can be applied in strips bridging only the joints between adjoining pieces of foam substrate. The layer of cementitious material 20 is then applied to the layer of reinforcing material 12 (or to the first primary surface 14 of the foam substrate 10, if the layer of reinforcing material is not present) and elastomeric weather membrane. The layer of decorative aggregate 22 is then applied to the layer of cementitious material 20, as described above.

While the concrete substrate 18 in accordance with the present invention can be used with conventional concrete, plaster or mortar mixes; i.e., concrete, plaster or mortar in which portland cement is the only cementitious material used in the concrete, it is preferred as a part of the present invention to use the concrete, plaster or mortar mixes disclosed in applicant's co-pending patent application Ser. No. 13/626,540 filed Sep. 25, 2012 (the disclosure of which is incorporated herein by reference in its entirety). Concrete is a composite material consisting of a mineral-based hydraulic binder which acts to adhere mineral particulates together in a solid mass; those particulates may consist of coarse aggregate (rock or gravel), fine aggregate (natural sand or crushed fines), and/or unhydrated or unreacted cement. Specifically, the concrete, mortar and plaster mix in accordance with the present invention comprises cementitious material, aggregate and water sufficient to at least partially hydrate the cementitious material. The amount of cementitious material used relative to the total weight of the concrete, mortar or plaster varies depending on the application and/or the strength of the concrete desired. Generally speaking, however, the cementitious material comprises approximately 25% to approximately 40% by weight of the total weight of the concrete, exclusive of the water, or 300 lbs/yd³ of concrete (177 kg/m³) to 1,100 lbs/yd³ of concrete (650 kg/m³) of concrete. The water-to-cementitious material ratio by weight is usually approximately 0.25 to approximately 0.7. Relatively low water-to-cementitious material ratios lead to higher strength but lower workability, while relatively high water-to-cementitious material ratios lead to lower strength, but better workability. Aggregate usually comprises 60% to 80% by volume of the concrete, mortar or plaster. However, the relative amount of cementitious material to aggregate to water is not a critical feature of the present invention; conventional amounts can be used. Nevertheless, sufficient cementitious material should be used to produce concrete, mortar or plaster with an ultimate compressive strength of at least 1,000 psi, preferably at least 2,000 psi, more preferably at least 3,000 psi, most preferably at least 4,000 psi, especially up to about 10,000 psi or more.

The aggregate used in the concrete, mortar or plaster used with the present invention is not critical and can be any aggregate typically used in concrete including, but not limited to, aggregate meeting the requirements of ASTM C33. The aggregate that is used in the concrete, mortar or plaster depends on the application and/or the strength of the concrete desired. Such aggregate includes, but is not limited to, fine aggregate, medium aggregate, coarse aggregate, sand, gravel, crushed stone, lightweight aggregate, recycled aggregate, such as from construction, demolition and excavation waste, and mixtures and combinations thereof.

The preferred cementitious material for use with the present invention comprises portland cement; preferably portland cement and one of slag cement or fly ash; and more preferably portland cement, slag cement and fly ash. Slag cement is also known as ground granulated blast-furnace slag (GGBFS). The cementitious material preferably comprises a reduced amount of portland cement and increased amounts of recycled supplementary cementitious materials; i.e., slag cement and/or fly ash. This results in cementitious material and concrete that is more environmentally friendly. One or more cementitious materials other than slag cement or fly ash can also replace the portland cement, in whole or in part. Such other cementitious or pozzolanic materials include, but are not limited to, silica fume; metakaolin; rice hull (or rice husk) ash; ground burnt clay bricks; brick dust; bone ash; animal blood; clay; other siliceous, aluminous or aluminosiliceous materials that react with calcium hydroxide in the presence of water; hydroxide-containing compounds, such as sodium hydroxide, magnesium hydroxide, or any other compound having reactive hydrogen groups, other hydraulic cements and other pozzolanic materials. The portland cement can also be replaced, in whole or in part, by one or more inert or filler materials other than portland cement, slag cement or fly ash. Such other inert or filler materials include, but are not limited to limestone powder; calcium carbonate; titanium dioxide; quartz; or other finely divided minerals that densify the hydrated cement paste.

The preferred cementitious material for use with a disclosed embodiment of the present invention comprises 0% to approximately 100% by weight portland cement; preferably, 0% to approximately 80% by weight portland cement. The ranges of 0% to approximately 100% by weight portland cement and 0% to approximately 80% by weight portland cement include all of the intermediate percentages; such as, 5%, 10%, 15%, 20%, 25%, 30%, 35%, 40%, 45%, 50%, 55%, 60%, 65%, 70%, 75%, 80%, 85%, 90% and 95%. The cementitious material of the present invention can also comprise 0% to approximately 90% by weight portland cement, preferably 0% to approximately 80% by weight portland cement, preferably 0% to approximately 70% by weight portland cement, more preferably 0% to approximately 60% by weight portland cement, most preferably 0% to approximately 50% by weight portland cement, especially 0% to approximately 40% by weight portland cement, more especially 0% to approximately 30% by weight portland cement, most especially 0% to approximately 20% by weight portland cement, or 0% to approximately 10% by weight portland cement. In one disclosed embodiment, the cementitious material comprises approximately 10% to approximately 45% by weight portland cement, more preferably approximately 10% to approximately 40% by weight portland cement, most preferably approximately 10% to approximately 35% by weight portland cement, especially approximately 33⅓% by weight portland cement, most especially approximately 10% to approximately 30% by weight portland cement. In another disclosed embodiment of the present invention, the cementitious material comprises approximately 5% by weight portland cement, approximately 10% by weight portland cement, approximately 15% by weight portland cement, approximately 20% by weight portland cement, approximately 25% by weight portland cement, approximately 30% by weight portland cement, approximately 35% by weight portland cement, approximately 40% by weight portland cement, approximately 45% by weight portland cement or approximately 50% by weight portland cement or any sub-combination thereof.

The preferred cementitious material for use in one disclosed embodiment of the present invention also comprises 0% to approximately 90% by weight slag cement, preferably approximately 20% to approximately 90% by weight slag cement, more preferably approximately 30% to approximately 80% by weight slag cement, most preferably approximately 30% to approximately 70% by weight slag cement, especially approximately 30% to approximately 60% by weight slag cement, more especially approximately 30% to approximately 50% by weight slag cement, most especially approximately 30% to approximately 40% by weight slag cement. In another disclosed embodiment the cementitious material comprises approximately 33⅓% by weight slag cement. In another disclosed embodiment of the present invention, the cementitious material can comprise approximately 5% by weight slag cement, approximately 10% by weight slag cement, approximately 15% by weight slag cement, approximately 20% by weight slag cement, approximately 25% by weight slag cement, approximately 30% by weight slag cement, approximately 35% by weight slag cement, approximately 40% by weight slag cement, approximately 45% by weight slag cement, approximately 50% by weight slag cement, approximately 55% by weight slag cement, approximately 60% by weight slag cement, approximately 65%, approximately 70% by weight slag cement, approximately 75% by weight slag cement, approximately 80% by weight slag cement, approximately 85% by weight slag cement or approximately 90% by weight slag cement or any sub-combination thereof.

The preferred cementitious material for use in one disclosed embodiment of the present invention also comprises 0% to approximately 50% by weight fly ash; preferably approximately 10% to approximately 45% by weight fly ash, more preferably approximately 10% to approximately 40% by weight fly ash, most preferably approximately 10% to approximately 35% by weight fly ash, especially approximately 33⅓% by weight fly ash. In another disclosed embodiment of the present invention, the preferred cementitious material comprises 0% by weight fly ash, approximately 5% by weight fly ash, approximately 10% by weight fly ash, approximately 15% by weight fly ash, approximately 20% by weight fly ash, approximately 25% by weight fly ash, approximately 30% by weight fly ash, approximately 35% by weight fly ash, approximately 40% by weight fly ash, approximately 45% by weight fly ash or approximately 50% by weight fly ash or any sub-combination thereof. Preferably the fly ash has an average particle size of <10 μm; more preferably 90% or more of the particles have a particles size of <10 μm.

The preferred cementitious material for use in one disclosed embodiment of the present invention also comprises 0% to approximately 80% by weight fly ash, preferably approximately 10% to approximately 75% by weight fly ash, preferably approximately 10% to approximately 70% by weight fly ash, preferably approximately 10% to approximately 65% by weight fly ash, preferably approximately 10% to approximately 60% by weight fly ash, preferably approximately 10% to approximately 55% by weight fly ash, preferably approximately 10% to approximately 50% by weight fly ash, preferably approximately 10% to approximately 45% by weight fly ash, more preferably approximately 10% to approximately 40% by weight fly ash, most preferably approximately 10% to approximately 35% by weight fly ash, especially approximately 33⅓% by weight fly ash. In another disclosed embodiment of the present invention, the preferred cementitious material comprises 0% by weight fly ash, approximately 5% by weight fly ash, approximately 10% by weight fly ash, approximately 15% by weight fly ash, approximately 20% by weight fly ash, approximately 25% by weight fly ash, approximately 30% by weight fly ash, approximately 35% by weight fly ash, approximately 40% by weight fly ash, approximately 45% by weight fly ash or approximately 50% by weight fly ash, approximately 55% by weight fly ash, approximately 60% by weight fly ash, approximately 65% by weight fly ash, approximately 70% by weight fly ash or approximately 75% by weight fly ash, approximately 80% by weight fly ash or any sub-combination thereof. Preferably the fly ash has an average particle size of <10 μm; more preferably 90% or more of the particles have a particles size of <10 μm.

In one disclosed embodiment, the preferred cementitious material for use with the present invention comprises approximately equal parts by weight of portland cement, slag cement and fly ash; i.e., approximately 33⅓% by weight portland cement, approximately 33⅓% by weight slag cement and approximately 33⅓% by weight fly ash. In another disclosed embodiment, a preferred cementitious material for use with the present invention has a weight ratio of portland cement to slag cement to fly ash of 1:1:1. In another disclosed embodiment, the preferred cementitious material for use with the present invention has a weight ratio of portland cement to slag cement to fly ash of approximately 0.85-1.15:0.85-1.15:0.85-1.15, preferably approximately 0.9-1.1:0.9-1.1:0.9-1.1, more preferably approximately 0.95-1.05:0.95-1.05:0.95-1.05.

The cementitious material disclosed above can also optionally include 0% to approximately 50% by weight ceramic fibers, preferably 0% to 40% by weight ceramic fibers, more preferably 0% to 30% by weight ceramic fibers, most preferably 0% to 20% by weight ceramic fibers, especially 0% to 15% by weight ceramic fibers, more especially 0% to 10% by weight ceramic fibers, most especially 0% to 5% by weight ceramic fibers. Wollastonite is an example of a ceramic fiber. Wollastonite is a calcium inosilicate mineral (CaSiO₃) that may contain small amounts of iron, magnesium, and manganese substituted for calcium. In addition the cementitious material can optionally include 0.1-25% calcium oxide (quick lime), calcium hydroxide (hydrated lime), calcium carbonate or latex or polymer admixtures, either mineral or synthetic, that have reactive hydroxyl groups.

In one disclosed embodiment, the cementitious material for use with the present invention comprises 0% to approximately 100% by weight portland cement, 0% to approximately 90% by weight slag cement, and 0% to approximately 80% by weight fly ash. In one disclosed embodiment, the cementitious material for use with the present invention comprises 0% to approximately 80% by weight portland cement, 0% to approximately 90% by weight slag cement, and 0% to approximately 80% by weight fly ash. In another disclosed embodiment, the cementitious material for use with the present invention comprises 0% to approximately 70% by weight portland cement, 0% to approximately 90% by weight slag cement, and 0% to approximately 80% by weight fly ash. In another disclosed embodiment, the cementitious material for use with the present invention comprises 0% to approximately 60% by weight portland cement, 0% to approximately 90% by weight slag cement, and 0% to approximately 80% by weight fly ash. In another disclosed embodiment, the cementitious material for use with the present invention comprises 0% to approximately 50% by weight portland cement, 0% to approximately 90% by weight slag cement, and 0% to approximately 80% by weight fly ash. In another disclosed embodiment, the cementitious material for use with the present invention comprises less than 50% by weight portland cement, 10% to approximately 90% by weight slag cement, and 10% to approximately 80% by weight fly ash. In another disclosed embodiment, the cementitious material for use with the present invention comprises approximately 10% to approximately 45% by weight portland cement, approximately 10% to approximately 90% by weight slag cement, and 10% to approximately 80% by weight fly ash. In another disclosed embodiment, the cementitious material for use with the present invention comprises approximately 10% to approximately 40% by weight portland cement, approximately 10% to approximately 90% by weight slag cement, and 10% to approximately 80% by weight fly ash. In another disclosed embodiment, the cementitious material for use with the present invention comprises approximately 10% to approximately 35% by weight portland cement, approximately 10% to approximately 90% by weight slag cement, and 10% to approximately 80% by weight fly ash.

In another disclosed embodiment, the cementitious material for use with the present invention comprises 0% to approximately 100% by weight portland cement; 0% to approximately 90% by weight slag cement; 0% to approximately 80% by weight fly ash; 0% to 10% by weight ceramic fiber; and 0% to approximately 25% by weight calcium oxide, calcium hydroxide, latex, acrylic or polymer admixtures, either mineral or synthetic, that have reactive hydroxyl groups, or mixtures thereof. In one disclosed embodiment, the cementitious material for use with the present invention comprises 0% to approximately 80% by weight portland cement; 0% to approximately 90% by weight slag cement; 0% to approximately 80% by weight fly ash; 0% to approximately 20% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises 0% to approximately 70% by weight portland cement; 0% to approximately 90% by weight slag cement; 0% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises 0% to approximately 60% by weight portland cement; 0% to approximately 90% by weight slag cement; 0% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises 0% to approximately 50% by weight portland cement; 0% to approximately 90% by weight slag cement; 0% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises less than 50% by weight portland cement; 10% to approximately 90% by weight slag cement; 10% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises approximately 10% to approximately 45% by weight portland cement; approximately 10% to approximately 90% by weight slag cement; 10% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises approximately 10% to approximately 40% by weight portland cement; approximately 10% to approximately 90% by weight slag cement; 10% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises approximately 10% to approximately 35% by weight portland cement; approximately 10% to approximately 90% by weight slag cement; 10% to approximately 80% by weight fly ash; 0% to approximately 10% by weight ceramic fiber; and 0% to approximately 25% by weight calcium oxide, calcium hydroxide, or latex or polymer admixtures, either mineral or synthetic, that have reactive hydroxyl groups, or mixtures thereof.

In another disclosed embodiment, the cementitious material for use with the present invention comprises 0% to approximately 100% by weight portland cement; 0% to approximately 90% by weight slag cement; 0% to approximately 80% by weight fly ash; and 0.1% to 15% by weight ceramic fiber. In one disclosed embodiment, the cementitious material for use with the present invention comprises 0% to approximately 80% by weight portland cement; 0% to approximately 90% by weight slag cement; 0% to approximately 80% by weight fly ash; and 0.1% to approximately 15% by weight ceramic fiber. In another disclosed embodiment, the cementitious material for use with the present invention comprises 0% to approximately 70% by weight portland cement; 0% to approximately 90% by weight slag cement; 0% to approximately 80% by weight fly ash; and 0.1% to approximately 10% by weight ceramic fiber. In another disclosed embodiment, the cementitious material for use with the present invention comprises 0% to approximately 60% by weight portland cement; 0% to approximately 90% by weight slag cement; 0% to approximately 80% by weight fly ash; and 0.1% to approximately 10% by weight ceramic fiber. In another disclosed embodiment, the cementitious material for use with the present invention comprises 0% to approximately 50% by weight portland cement; 0% to approximately 90% by weight slag cement; 0% to approximately 80% by weight fly ash; and 0.1% to approximately 10% by weight ceramic fiber. In another disclosed embodiment, the cementitious material for use with the present invention comprises less than 50% by weight portland cement; 10% to approximately 90% by weight slag cement; 10% to approximately 80% by weight fly ash; and 0.1% to approximately 10% by weight ceramic fiber. In another disclosed embodiment, the cementitious material for use with the present invention comprises approximately 10% to approximately 45% by weight portland cement; approximately 10% to approximately 90% by weight slag cement; 10% to approximately 80% by weight fly ash; and 0.1% to approximately 10% by weight ceramic fiber. In another disclosed embodiment, the cementitious material for use with the present invention comprises approximately 10% to approximately 40% by weight portland cement; approximately 10% to approximately 90% by weight slag cement; 10% to approximately 80% by weight fly ash; and 0.1% to approximately 10% by weight ceramic fiber. In another disclosed embodiment, the cementitious material for use with the present invention comprises approximately 10% to approximately 35% by weight portland cement; approximately 10% to approximately 90% by weight slag cement; 10% to approximately 80% by weight fly ash; and 0.1% to approximately 10% by weight ceramic fiber.

In another disclosed embodiment, the cementitious material for use with the present invention comprises 0% to approximately 100% by weight portland cement; 0% to approximately 90% by weight slag cement; 0% to approximately 80% by weight fly ash; 0% to 30% by weight Wollastonite; and 0% to approximately 25% by weight calcium oxide, calcium hydroxide, latex, acrylic or polymer admixtures, either mineral or synthetic, that have reactive hydroxyl groups, or mixtures thereof. In one disclosed embodiment, the cementitious material for use with the present invention comprises 0% to approximately 80% by weight portland cement; 0% to approximately 90% by weight slag cement; 0% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises 0% to approximately 70% by weight portland cement; 0% to approximately 90% by weight slag cement; 0% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises 0% to approximately 60% by weight portland cement; 0% to approximately 90% by weight slag cement; 0% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises 0% to approximately 50% by weight portland cement; 0% to approximately 90% by weight slag cement; 0% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises less than 50% by weight portland cement; 10% to approximately 90% by weight slag cement; 10% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises approximately 10% to approximately 45% by weight portland cement; approximately 10% to approximately 90% by weight slag cement; 10% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises approximately 10% to approximately 40% by weight portland cement; approximately 10% to approximately 90% by weight slag cement; 10% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof. In another disclosed embodiment, the cementitious material for use with the present invention comprises approximately 10% to approximately 35% by weight portland cement; approximately 10% to approximately 90% by weight slag cement; 10% to approximately 80% by weight fly ash; 0% to approximately 30% by weight Wollastonite; and 0% to approximately 25% by weight calcium oxide, calcium hydroxide, or latex or polymer admixtures, either mineral or synthetic, that have reactive hydroxyl groups, or mixtures thereof.

In another disclosed embodiment, the cementitious material for use with the present invention comprises 0% to approximately 100% by weight portland cement; 0% to approximately 90% by weight slag cement; 0% to approximately 80% by weight fly ash; and 0.1% to 30% by weight Wollastonite. In one disclosed embodiment, the cementitious material for use with the present invention comprises 0% to approximately 80% by weight portland cement; 0% to approximately 90% by weight slag cement; 0% to approximately 80% by weight fly ash; and 0.1% to approximately 30% by weight Wollastonite. In another disclosed embodiment, the cementitious material for use with the present invention comprises 0% to approximately 70% by weight portland cement; 0% to approximately 90% by weight slag cement; 0% to approximately 80% by weight fly ash; and 0.1% to approximately 30% by weight Wollastonite. In another disclosed embodiment, the cementitious material for use with the present invention comprises 0% to approximately 60% by weight portland cement; 0% to approximately 90% by weight slag cement; 0% to approximately 80% by weight fly ash; and 0.1% to approximately 30% by weight Wollastonite. In another disclosed embodiment, the cementitious material for use with the present invention comprises 0% to approximately 50% by weight portland cement; 0% to approximately 90% by weight slag cement; 0% to approximately 80% by weight fly ash; and 0.1% to approximately 30% by weight Wollastonite. In another disclosed embodiment, the cementitious material for use with the present invention comprises less than 50% by weight portland cement; 10% to approximately 90% by weight slag cement; 10% to approximately 80% by weight fly ash; and 0.1% to approximately 30% by weight Wollastonite. In another disclosed embodiment, the cementitious material for use with the present invention comprises approximately 10% to approximately 45% by weight portland cement; approximately 10% to approximately 90% by weight slag cement; 10% to approximately 80% by weight fly ash; and 0.1% to approximately 30% by weight Wollastonite. In another disclosed embodiment, the cementitious material for use with the present invention comprises approximately 10% to approximately 40% by weight portland cement; approximately 10% to approximately 90% by weight slag cement; 10% to approximately 80% by weight fly ash; and 0.1% to approximately 30% by weight Wollastonite. In another disclosed embodiment, the cementitious material for use with the present invention comprises approximately 10% to approximately 35% by weight portland cement; approximately 10% to approximately 90% by weight slag cement; 10% to approximately 80% by weight fly ash; and 0.1% to approximately 30% by weight Wollastonite.

In another disclosed embodiment, the cementitious material for use with the present invention comprises 0% to approximately 100% by weight portland cement; 0% to approximately 90% by weight slag cement; 0% to approximately 80% by weight fly ash, wherein the combination of portland cement, slag cement and fly ash comprise at least 50% by weight; and 0.1% to approximately 50% by weight polymer for making polymer modified concrete, mortar or plaster. In another disclosed embodiment, the cementitious material for use with the present invention comprises approximately 10% to approximately 45% by weight portland cement; approximately 10% to approximately 90% by weight slag cement; 10% to approximately 80% by weight fly ash; and 0.1% to approximately 50% by weight polymer for making polymer modified concrete, mortar or plaster.

In another disclosed embodiment, the cementitious material for use with the present invention comprises 0% to approximately 100% by weight portland cement; 0% to approximately 90% by weight slag cement; 0% to approximately 80% by weight fly ash, wherein the combination of portland cement, slag cement and fly ash comprise at least 50% by weight; and 0.1% to approximately 50% by weight ceramic fiber. In another disclosed embodiment, the cementitious material for use with the present invention comprises approximately 10% to approximately 45% by weight portland cement; approximately 10% to approximately 90% by weight slag cement; 10% to approximately 80% by weight fly ash; and 0.1% to approximately 50% by weight ceramic fiber.

In another disclosed embodiment, the cementitious material for use with the present invention comprises 0% to approximately 100% by weight portland cement; 0% to approximately 90% by weight slag cement; 0% to approximately 80% by weight fly ash, wherein the combination of portland cement, slag cement and fly ash comprise at least 50% by weight; 0.1% to approximately 50% by weight ceramic fiber and 0.1% to approximately 50% by weight polymer for making polymer modified concrete, mortar or plaster. In another disclosed embodiment, the cementitious material for use with the present invention comprises approximately 10% to approximately 45% by weight portland cement; approximately 10% to approximately 90% by weight slag cement; 10% to approximately 80% by weight fly ash; and 0.1% to approximately 50% by weight ceramic fiber and 0.1% to approximately 50% by weight polymer for making polymer modified concrete, mortar or plaster.

The portland cement, slag cement and fly ash can be combined physically or mechanically in any suitable manner and is not a critical feature. For example, the portland cement, slag cement and fly ash can be mixed together to form a uniform blend of dry material prior to combining with the aggregate and water. If dry polymer powder is used, it can be combined with the cementitious material and mixed together to form a uniform blend prior to combining with the aggregate or water. If the polymer is a liquid, it can be added to the cementitious material and combined with the aggregate and water. Or, the portland cement, slag cement and fly ash can be added separately to a conventional concrete mixer, such as the transit mixer of a ready-mix concrete truck, at a batch plant. The water and aggregate can be added to the mixer before the cementitious material, however, it is preferable to add the cementitious material first, the water second, the aggregate third and any makeup water last.

Chemical admixtures can also be used with the preferred concrete for use with the present invention. Such chemical admixtures include, but are not limited to, accelerators, retarders, air entrainments, plasticizers, superplasticizers, coloring pigments, corrosion inhibitors, bonding agents and pumping aid. Although chemical admixtures can be used with the concrete of the present invention, it is believed that chemical admixtures are not necessary.

Mineral admixtures or additional supplementary cementitious material (“SCM”) can also be used with the concrete of the present invention. Such mineral admixtures include, but are not limited to, silica fume, glass powder and high reactivity metakaolin. Although mineral admixtures can be used with the concrete of the present invention, it is believed that mineral admixtures are not necessary.

It is specifically contemplated that the cementitious-based material from which the layer of cementitious material 20 is made can include reinforcing fibers made from material including, but not limited to, steel, plastic polymers, glass, basalt, Wollastonite, carbon, cellulose and the like. The use of reinforcing fiber in the layer of cementitious material 20 made from polymer modified concrete, mortar or plaster provide the layer of cementitous material with improved flexural strength, as well as improved wind load capability and blast resistance.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A product comprising:
a substrate having a first primary surface and an opposite second primary surface;
a layer of cementitious material on the first primary surface; and
decorative aggregate particles partially embedded in the layer of cementitious material.

2. The product of claim 1 further comprising a layer of concrete on the second primary surface.

3. The product of claim 1, wherein the substrate comprises a foam insulating panel and further comprising a layer of reinforcing material disposed between the foam insulating panel and the layer of cementitious material.

4. The product of claim 1, wherein approximately 10% of the surface area of the decorative aggregate particles are embedded in the layer of cementitious material.

5. The product of claim 1, wherein approximately 25% of the surface area of the decorative aggregate particles are embedded in the layer of cementitious material.

6. The product of claim 1, wherein approximately 50% of the surface area of the decorative aggregate particles are embedded in the layer of cementitious material.

7. The product of claim 1, wherein approximately 75% of the surface area of the decorative aggregate particles are embedded in the layer of cementitious material.

8. The product of claim 3, wherein the layer of reinforcing material is adhered to the first primary surface by a water-resistant polymer coating.

9. The product of claim 1, wherein the decorative aggregate particles are colorful stone, semi-precious stone, quartz, granite, basalt, marble, stone pebbles, glass or shells.

10. The product of claim 1, wherein the decorative aggregate particles are stone or crushed glass.

11. The product of claim 1, wherein the decorative aggregate particles are recycled clear glass, recycled mirror glass, recycled clear plate glass, recycled cobalt blue glass, recycled mixed plate glass, recycled black glass, artificially colored glass, reflective glass, transparent glass, opaque glass, frosted glass or coated glass.

12. A method comprising:
applying a layer of cementitious material to a first primary surface of a substrate; and
partially embedding decorative aggregate particles in the layer of cementitious material before the layer of cementitious material has reached final set or cure.

13. The method of claim 12, wherein the decorative aggregate particles are applied by broadcasting.

14. The method of claim 12, wherein approximately 10% of the surface area of the decorative aggregate particles are embedded in the layer of cementitious material.

15. The method of claim 12, wherein approximately 25% of the surface area of the decorative aggregate particles are embedded in the layer of cementitious material.

16. The method of claim 12, wherein approximately 50% of the surface area of the decorative aggregate particles are embedded in the layer of cementitious material.

17. The method of claim 12, wherein approximately 75% of the surface area of the decorative aggregate particles are embedded in the layer of cementitious material.

18. The method of claim 12, wherein the substrate is a foam insulating panel and further comprising a layer of reinforcing material disposed between the foam insulating panel and the layer of cementitious material.

19. The method of claim 12, wherein the decorative aggregate particles are colorful stone, semi-precious stone, quartz, granite, basalt, marble, stone pebbles, crushed glass or shells.

20. The method of claim 12, wherein the decorative aggregate particles are recycled clear glass, recycled mirror glass, recycled clear plate glass, recycled cobalt blue glass, recycled mixed plate glass, recycled black glass, artificially colored glass, reflective glass, transparent glass, opaque glass, frosted glass or coated glass.
